(19) United States
(12) Patent Application Publication
(10) Pub. No.: US 2001/0037833 A1
(43) Pub. Date: Nov. 8, 2001

(54) Device for actuating an overflow valve

(75) Inventor: Leopold von Keudell, Salem (DE)

Correspondence Address: Pandiscio & Pandiscio, 470 Totten Pond Road, Waltham, MA, 02451-1914, US

(73) Assignee: J. Wagner GmbH

(21) Appl. No.: 09/826,086

(22) Filed: Apr. 4, 2001

(30) Foreign Application Priority Data
May 4, 2000 (DE) 200 08 051.2

(51) Int. Cl. F16K 11/00

(52) U.S. Cl. 137/881

(57) ABSTRACT

In a device (1) for actuating an overflow valve (5), in particular an overflow valve (5) incorporated in a return line (4) of a feed pump (2) and comprising a valve housing (6) and a valve body (7), the valve housing (6) of which is inserted in a fixed position in a housing (3) of the feed pump (2), with a compression spring (8) arranged between the valve housing (6) and the valve body (7) of the overflow valve (5) and a joining piece (11) attached to the valve body (7) of the overflow valve (5), with the joining piece (11) projecting from the valve housing (6) of the overflow valve (5) and having a position switch (12) assigned to the feed pump (2) held onto it via an adapter (9) which is fixed into the housing (3) of the feed pump (2), both the axial adjustment of the overflow valve (5) and the actuation of the control electronics of the feed pump (2) should be undertaken using a common housing (2); in addition, it should be possible for the procedures for assembling and dismantling the components of the device (1) to be carried out quickly and uncomplicatedly. This is achieved by arranging electrical, pneumatic, hydraulic and/or mechanical components for controlling the feed pump (2) inside the adapter (9), and because these components can be actuated by the position switch (12) using a control surface (38) running in a circumferential direction.

The present invention concerns a device for actuating an overflow valve, in particular an overflow valve incorporated in a return line of a feed pump and comprising a valve housing and a valve body, the valve housing of which is inserted in a fixed position in a housing of the feed pump, with a compression spring arranged between the valve housing and the valve body of the overflow valve and a joining piece attached to the valve body of the overflow valve, with the joining piece projecting from the valve housing of the overflow valve and having a position switch assigned to the feed pump held onto it via an adapter which is fixed into the housing of the feed pump.

When feed pumps, in particular diaphragm pumps, are taken into operation, the fluid should be held in the feed lines of the feed pump without pressure so that the feed pump can start up without feed output in starting mode. For this purpose, it is necessary for some of the fluid which is going to be pumped by the feed pump to be pumped out of the return lines after the feed pump has been switched off, with this evacuation pumping lasting until the feed pressure has been reduced. Consequently, an overflow valve is provided in the return line, by means of which the excess pressure line is to be opened both in the event of excess pressure during operation of the feed pump and when the pump is switched off and on, so that there is no feed pressure in the feed line.

Such a device is described in U.S. Pat. No. 4,928,722, in which the position switch possesses a circumferential cam track which acts axially on a switching button of the control electronics for the feed pump. This means the electronics of the feed pump are to be actuated by the rotation of the position switch. The overflow valve is moved axially at the same time by the rotation of the position switch; this axial movement occurs because the position switch possess an internal cam track by means of which an axial movement is induced when the position switch is rotated. The valve body of the overflow valve and its joining piece are locked in the position switch.

With this device, it has proven to be a disadvantage that the control system for the electronics which influence the motor of the feed pump cannot be reliably actuated, because the overflow valve must be held in an open and a closed position by the position switch at the same time as the switching button of the motor electronics have to be held down by the position switch. The fact that the position switch has to be transferred into different and variable axial positions means that the cam track which is assigned to the control switch of the motor electronics has to satisfy exacting requirements and so the position switch is expensive to manufacture.

Also, achieving a seal between the housing of the feed pump and the position switch involves considerable difficulties because the axial movement of the control switch prevents the use of a reliable seal, for instance an O-ring seal.

Furthermore, separating the mechanical axial adjustment mechanism of the overflow valve from the control electronics of the feed pump is not a technically elegant solution because the spatial separation and the axial actuation of the control switch for the motor electronics place great demands on the design and configuration of the position switch. This means that considerable time has to be expended when changing the overflow valve, and also that the operating personnel has to cope with more exacting demands in order to be able to assemble and dismantle these components.

In feed pumps of prior art, the position switch which actuates the overflow valve from outside is arranged in the housing of the pump separately from the electronics which control the pump. The position switch not only switches the overflow valve but also the electronics for the feed pump. Frequently, however, the overflow valve is arranged in the housing in such a way that the forces for moving the overflow valve have to be absorbed directly by the position switch or its housing.

As a result, it is the purpose of the present invention to develop the device for actuating an overflow valve of the aforementioned type in such a way that both the axial adjustment of the overflow valve and the actuation of the control electronics of the feed pump are to be undertaken using a common housing and that the procedures for assembling and dismantling the components of the device can be carried out quickly and uncomplicatedly.

In accordance with the present invention, this task is accomplished in that electrical, pneumatic, hydraulic and/or mechanical components for controlling the feed pump are arranged inside the adapter, and that these components can be actuated by the position switch using a control surface running in a circumferential direction along the position switch.

Torque for the axial movement of the valve body is transmitted between the position switch and the overflow valve by means of a locating hole worked into the end of the joining piece assigned to the position switch, while a pin locked into the position switch running perpendicular to the longitudinal axis of the joining piece projects through the locating hole in the joining piece.

Due to the fact that at least two control surfaces are installed in the position switch and run at an angle in the circumferential direction of the position switch, and that cams corresponding to the control surfaces of the position switch are worked onto the adapter, it is assured that the overflow valve can be moved to various positions by the position switch in relation to the axial direction of the overflow valve, which means the mechanical connection between the position switch and the joining piece of the overflow valve enables the required operating mode of the overflow valve to be selected or set. At the same time, the position switch also controls the electronics arranged in the adapter, which means the rotation of the position switch can be used for setting the operating mode of the feed pump in relation to the position of the overflow valve.

There is an oval or polygonal accommodation opening in the housing of the feed pump in order to absorb the torques present in the adapter and the position switch and to lock the adapter to prevent it from rotating, so that the torques which occur are directly transmitted into the housing of the feed pump.

Further advantageous embodiments of the invention are apparent from the subordinate claims.

In the arrangement of the adapter on the housing of the feed pump in accordance with the present invention, it is an advantage that the overflow valve is arranged without play and is not in contact with the adapter. As a result, there is no force transmission between the overflow valve and the adapter. Instead, this process occurs directly within the housing of the feed pump, because the valve housing is screwed into the housing of the feed pump. The position switch only transmits the axial forces of the spring onto the adapter.

A configuration of this type also significantly facilitates assembly and dismantling of the adapter, the overflow valve and the position switch, for example, in comparison to the design according to prior art, because the individual components can be removed separately or together from the housing of the feed pump.

The electronics arranged in the adapter are needed for controlling the feed pump and are not affected when the adapter is removed, because the electrical circuit elements are mounted in a fixed position in the adapter and are only connected to the pump in the housing of the feed pump by means of an electrical control cable. This ensures it is a quick and simple matter to dismantle or assemble the individual components, namely the adapter, the overflow valve and the position switch together with the electronics fitted in the adapter.

The drawing shows a sample embodiment configured in accordance with the present invention, the details of which are explained below. In the drawing,

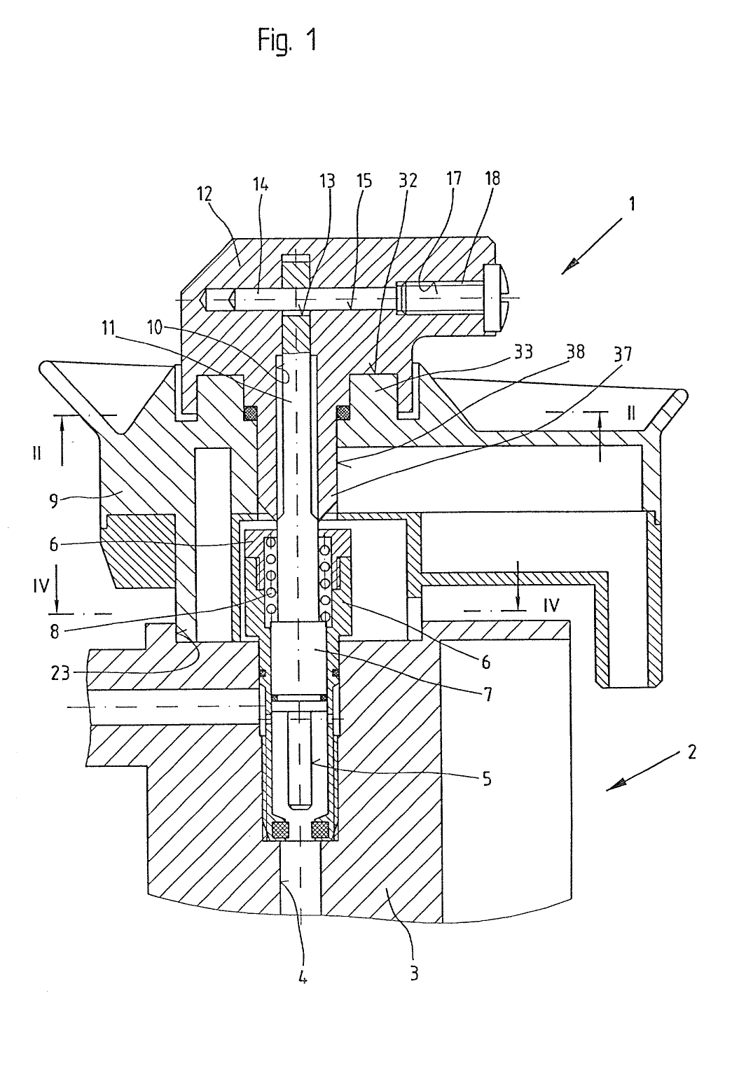

FIG. 1 shows a device for actuating an overflow valve on a housing of a feed pump, as a sectional view,

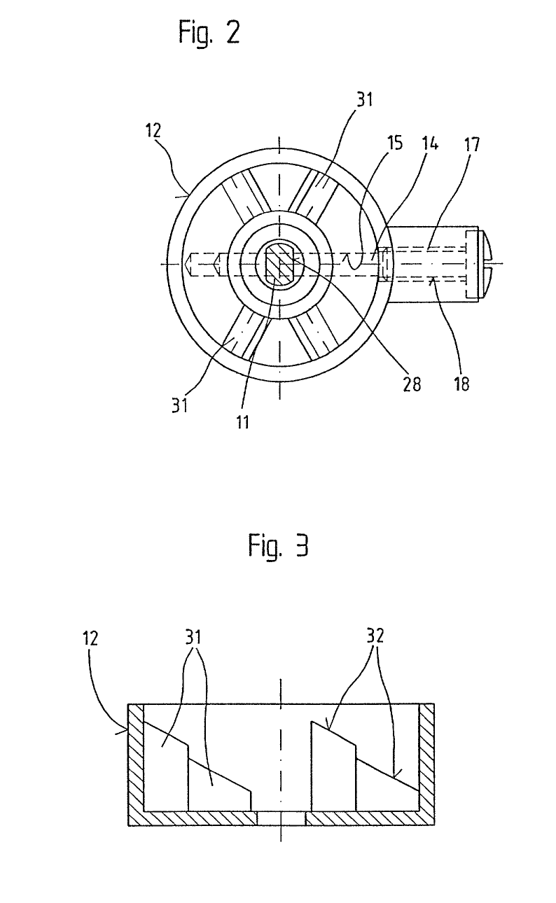

FIG. 2 shows a position switch of the device according to FIG. 1, as a plan view,

FIG. 3 shows a developed view of the position switch according to FIG. 2,

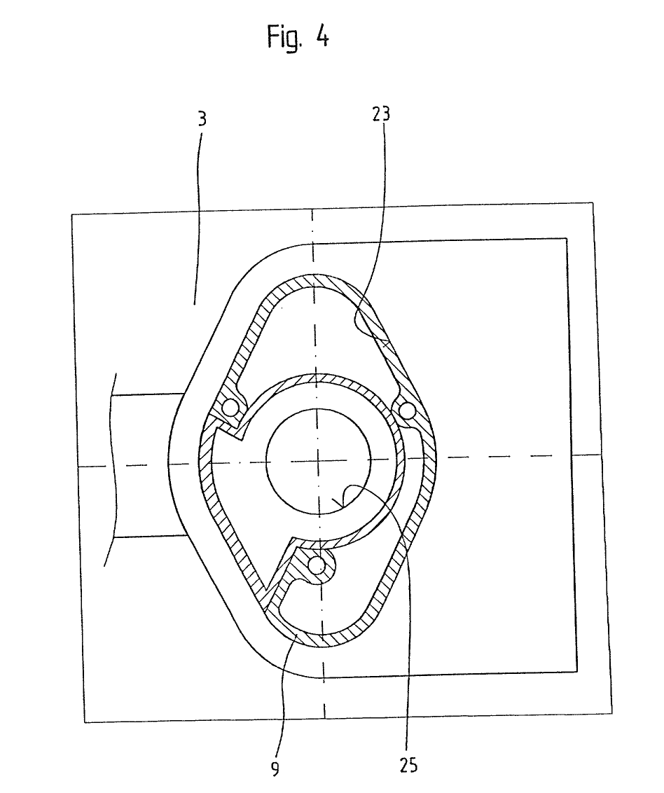

FIG. 4 shows the housing of the feed pump for accommodating the device in accordance with FIG. 1 and

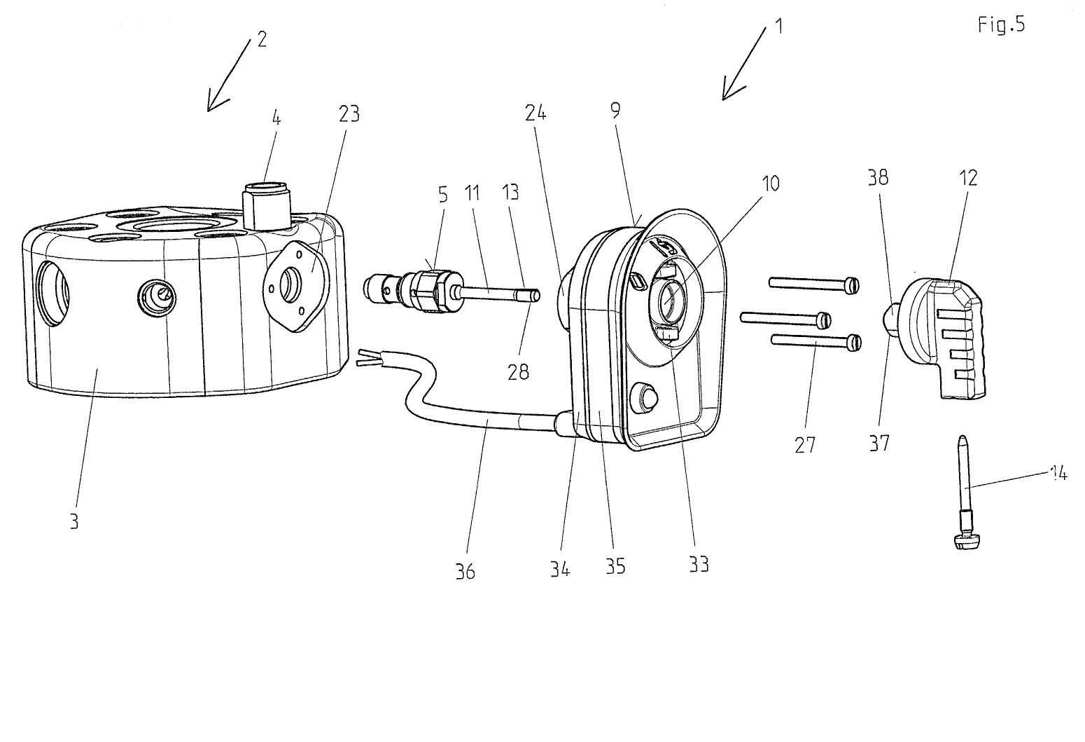

FIG. 5 shows the device in accordance with FIG. 1, as an exploded view.

FIG. 1 shows a device 1 for actuating an overflow valve 5 arranged in a return line 4 of a feed pump 2. The overflow valve 5 comprises a two-part valve housing 6 and a valve body 7 which is shown in the open position so that the return line 4 is clear. The two-part valve housing 6 is screwed into a housing 3 of the feed pump 2; both parts of the valve housing 6 are connected together in the form of a screw connection. A compression spring 8 is arranged between the valve housing 6 and the valve body 7 to ensure normal valve control in the operating mode of the feed pump 2. Consequently, if there is an increased fluid pressure in the return line 4 acting on the surface of the overflow valve 5 facing away from the valve body 7, then the overflow valve 5 is opened irrespective of its setting and the excess pressure in the normal feed circuit of the feed pump 2 is dissipated because the overflow valve 5 is open.

Furthermore, an adapter 9 is supported against the housing 3 of the feed pump 2 and the adapter 9 possesses a hole 10 for accommodating a joining piece 11 fitted to the valve body 7. As a result, the joining piece 11 projects through the adapter 9, out of its open end and out of the adapter 9.

The free end of the joining piece 11 is held in a position switch 12. The mechanical connection between the position switch 12 and the joining piece 11 takes the form of a locating hole 13 provided in the area of the free end of the joining piece 11 and a pin 14 projecting through the locating hole 13 of the joining piece 11 perpendicular to the longitudinal axis of the joining piece 11. The free end of the pin 14 is held in a blind hole 15 which is worked into the position switch 12. In addition, the position switch 12 possesses a threaded hole 17 which is assigned to the head end of the pin 14 in assembled condition. An external thread 18 is provided on the head end of the pin 14 so that the pin 14 is screwed into the position switch 12 and is therefore firmly locked into it.

In accordance with FIGS. 2 and 3, the position switch 12—when in the assembled condition—possesses four ribs 31 pointing in the direction of the adapter 9, each of which forms a control surface 32 running at an angle. The ribs 31 are evenly spaced in the circumferential direction of the control switch 12 and are arranged symmetrically in relation to the transverse axis of the control switch 12. This means both halves of the control switch are configured identically to one another, so that the control switch 12 can be connected to the adapter 9 in two positions.

Two cams 33 pointing towards the control switch 12 are formed onto the adapter 9, with the control surfaces 32 of the ribs 31 being held in a guided arrangement against the cams 33. The inclined control surfaces 32 acting in conjunction with the rotation of the control switch 12 therefore ensure that the joining piece 11 connected to the control switch 12 describes an axial movement.

As can be seen in FIG. 2 in particular, the free end of the joining piece 11 has a chamfer 28 which is configured and acts in conjunction with the locating hole of the position switch 12 in such a way that the joining piece 11 can be introduced into the locating hole of the position switch 12 with the result that the locating hole 13 of the joining piece 11 points towards the locating hole for the pin 14 locking the joining piece 11 within the position switch 12, and therefore the pin 14 can be pushed through the locating hole 13 after the joining piece 11 has been introduced into the position switch 12.

Furthermore, the chamfer 28 guarantees that the overflow valve 5 can be attached in a defined position in the position switch 12, so that the position switch 12 together with the electronics (not shown) inside the adapter 9 permit both the feed pump 2 and the overflow valve 5 to be controlled.

FIG. 4 shows an oval-shaped accommodation opening 23 for holding the adapter 9, with the aforementioned opening 23 being worked into the housing 3 of the feed pump 2. The adapter 9 can be inserted into it to form a non-rotating connection. The oval configuration of the accommodation opening 23 means the adapter 9 cannot 5 rotate.

As can be seen in FIG. 5, the adapter 9 is made up of two housing components 34, 35 which can be fixed to one another and onto the housing 3 of the feed pump 2 by means of fastening bolts 27 which pass through the adapter 9. It is also possible for the adapter 9 to be attached to the housing 3 of the feed pump 2 irrespective of the locking mechanism for both housing components 34 and 35. Furthermore, centring pins can be provided on the adapter 9 pointing towards the housing 3, so that the adapter 9 can be attached to the housing 3 in a predetermined position.

Electrical control devices (not shown) for the feed pump 2 are provided within the two housing components 34 and 35; these devices are connected to the feed pump 2 by means of an electrical cable 36. As such, the position switch 12 controls both the electronics provided in the adapter 9 and the position of the overflow valve 5.

The overflow valve 5 is assembled in such a way that a part of the valve housing 6 is screwed into the housing 3 of the feed pump 2. Then the overflow valve 5 is inserted into the outwardly open housing part of the valve housing 6 and the compression spring 8 is inserted. Then the second housing part of the valve housing 6 must be screwed onto the first part of the valve housing 6, so that the overflow valve 5 is firmly locked into the housing 3 of the feed pump 2 by means of the valve housing 6 which is configured in two parts. In this arrangement, the joining piece 11 of the overflow valve 5 projects out of the housing 3 of the feed pump 2. The through-hole 10 in the adapter 9 accommodates the joining piece 11 of the overflow valve 5. The fastening bolts 27 are used for bolting the two components of the adapter 9 onto the housing 3 of the feed pump 2.

The joining piece 11 projects from the adapter 9 and the position switch 12 is connected onto the joining piece 11. The chamfer 28 on the free end of the joining piece 11 permits the position switch 12 to be connected to it in a defined fashion. In order to attach the position switch 12 onto the joining piece 11, the pin 14 then has to be pushed into the hole provided for it within the position switch 12 which also projects through the joining piece 11 as a result of the locating hole 13. The thread 18 provided on the pin 14 is for locking the pin 14 into the position switch 12. Furthermore, the position switch 12 comprises a spigot 37 projecting towards the adapter 9, with this spigot 37 possessing a notch on its side which serves as a control surface 38 and, in conjunction with a contact surface in the hole 10 in the adapter 9, definitively determines a position of the position switch 12.

1. A device (1) for actuating an overflow valve (5), in particular an overflow valve (5) incorporated in a return line (4) of a feed pump (2) and comprising a valve housing (6) and a valve body (7), the valve housing (6) of which is inserted in a fixed position in a housing (3) of the feed pump (2), with a compression spring (8) arranged between the valve housing (6) and the valve body (7) of the overflow valve (5) and a joining piece (11) attached to the valve body (7) of the overflow valve (5), with the joining piece (11) projecting from the valve housing (6) of the overflow valve (5) and having a position switch (12) assigned to the feed pump (2) held onto it via an adapter (9) which is fixed into the housing (3) of the feed pump (2), characterised in that,
electrical, pneumatic, hydraulic and/or mechanical components for controlling the feed pump (2) are arranged inside the adapter (9), and that these components can be actuated by the position switch (12) using a control surface (38) running in a circumferential direction:

2. The device in accordance with claim 1, characterised in that,
a locating hole (13) is worked into the end of the joining piece (11) assigned to the position switch (12), and that a pin (14) locked into the position switch (12) running perpendicular to the longitudinal axis of the joining piece (11) projects through the locating hole (13) in the joining piece (11).

3. The device in accordance with claim 2, characterised in that,
the free end of the pin (14) is held in a blind hole (15) which is worked into the position switch (12) and that the head piece of the pin (14) is screwed into an internal thread (17) provided in the position switch (12).

4. The device in accordance with claim 2 or claim 3, characterised in that,
turning the position switch (12) causes the valve body (7) to be moved axially.

5. The device in accordance with one or more of the aforementioned claims, characterised in that,
at least two control surfaces (32) are attached to the position switch (12) and run at an angle in the circumferential direction of the position switch (12), and that cams (33) corresponding to the control surfaces (32) of the position switch (12) are worked onto the adapter (9).

6. The device in accordance with one or more of the aforementioned claims, characterised in that,
the adapter (9) and the position switch (12) can be removed separately or together from the housing (3) of the feed pump (2).

7. The device in accordance with one or more of the aforementioned claims, characterised in that,
an oval or polygonal accommodation opening (23) is provided in the housing (3) of the feed pump (2) in order to lock the adapter (9) to prevent it from rotating.

8. The device in accordance with claim 7, characterised in that,
a joining element (24) pointing towards the housing (3) of the feed pump (2) is provided on the adapter (9), with the external contour of the joining element (24) corresponding to the shape of the accommodation opening (23).

9. The device in accordance with one or more of the aforementioned claims, characterised in that,
the adapter (9) is made up of two housing components (34, 35).

10. The device in accordance with claim 9, characterised in that,
the housing component (34) allocated to the position switch (12) possesses an oval or polygonal projection encompassing the through-hole (10) provided for the passage through the overflow valve (5), with this projection projecting towards the second housing component (35) when the housing components (34, 35) are assembled, and that a recess corresponding to the external contour of the projection is worked into the second housing component (35).

11. The device in accordance with claim 9 or claim 10, characterised in that,
the two housing components (34, 35) are attached irrespective of the attachment of the adapter (9) to the feed pump (2).

12. The device in accordance with one or more of the aforementioned claims, characterised in that,
the cross section of the free end of the joining piece (11) possesses a cross sectional shape corresponding to the locating hole (15) in the position switch (12).

13. The device in accordance with claim 12, characterised in that,
the cross sectional shape in the locating hole (15) of the position switch (12) is formed in such a way that the joining piece (11) is held in a predetermined position in the position switch (12).

14. The device in accordance with claim 12 or claim 13, characterised in that,
a control surface (38) is worked into a spigot (37) of the position switch (12), that the spigot (37) can be inserted into the adapter (9) and that when the position switch (12) is assembled, the control surface (38) is in contact with a mating surface provided in the adapter (9).
